(19) United States
(12) Patent Application Publication
(10) Pub. No.: US 2020/0043259 A1
(43) Pub. Date: Feb. 6, 2020

(54) SYSTEM AND METHOD FOR ENHANCING VEHICLE USER EXPERIENCE

(71) Applicant: GM Global Technology Operations LLC, Detroit, MI (US)

(72) Inventor: Daniel P. Carlesimo, Macomb Township, MI (US)

(21) Appl. No.: 16/055,619

(22) Filed: Aug. 6, 2018

(51) Int. Cl. G07C 5/08; G09B 19/00

(52) U.S. Cl. CPC G07C 5/0825; G07C 5/0833; G09B 19/167; G07C 5/085; G09B 19/0053

(57) ABSTRACT

A low utilization monitoring system for a motor vehicle includes a user interface and an electronic control unit (ECU) that receives instructions from the user interface. An algorithm is implemented in the ECU. The algorithm monitors information associated with the operation of the motor vehicle, and, upon receiving instructions from the user interface, the ECU issues a low utilization code based on the information. The low utilization code is then associated to an instructional material that is conveyed back to the user.

### INTRODUCTION

The present disclosure relates to a system and method for enhancing the user experience of a driver or passenger in a vehicle. More specifically, the present disclosure relates to a system and method for monitoring utilization of vehicle functions, and for responding to low utilization by vehicle occupants.

Motor vehicles are complex platforms offering a growing number of customer-interfacing functions. Unlike other carry-on platforms, customers interact with the motor vehicle on the go, typically, having a different primary reason in mind for a function when actually experiencing the particular function. Further, different customers experience a function differently.

Thus, while current methods and systems achieve their intended purpose, there is a need for a new and improved system and method for implementing similar criteria to address customer perception of embedded functionalities.

### SUMMARY

According to several aspects, a low utilization monitoring system for a motor vehicle includes a user interface and an electronic control unit (ECU) that receives instructions from the user interface. An algorithm is implemented in the ECU. The algorithm monitors information associated with the operation of the motor vehicle, and, upon receiving instructions from the user interface, the ECU issues a low utilization code based on the information.

In an additional aspect of the present disclosure, a back office collects the low utilization code from the ECU during a remote diagnostic session.

In another aspect of the present disclosure, the back office correlates the low utilization code to specific instructional material hosted on a database, the back office tailoring the instructional material and sending the tailored instructional material to a user of the motor vehicle.

In another aspect of the present disclosure, the tailored instructional material is a document sent to the user.

In another aspect of the present disclosure, the tailored instructional material is audio or video material sent to the user by email or SMS.

In another aspect of the present disclosure, the tailored instructional material is pre-downloaded and made available to the user over the air.

In another aspect of the present disclosure, the tailored instructional material is displayed as a pop-up in the motor vehicle.

In another aspect of the present disclosure, the user provides feedback regarding the tailored instructional material received.

In another aspect of the present disclosure, the algorithm is software algorithm stored in a non-transitory computer readable mechanism associated with the ECU.

In another aspect of the present disclosure, the system further includes a storage device with a database, the storage device being embedded in the motor vehicle, the algorithm correlating the low utilization code with instructional material stored in the database and tailoring the instructional material, the ECU sending the tailored instructional material to a user of the motor vehicle.

In another aspect of the present disclosure, the user interface is a button on a control panel in the motor vehicle.

According to several aspects, a method for low utilization monitoring includes sending instructions from a user interface to an ECU and monitoring information associated with the operation of the motor vehicle. Upon receiving instructions from the user interface, the ECU issues a low utilization code based on the information.

In another aspect of the present disclosure, a back office collects the low utilization code from the ECU during a remote diagnostic session.

In another aspect of the present disclosure, the back office correlates the low utilization code to specific instructional material hosted on a database, the back office tailoring the instructional material and sending the tailored instructional material to a user of the motor vehicle.

In another aspect of the present disclosure, the tailored instructional material is a document sent to the user.

In another aspect of the present disclosure, the tailored instructional material is audio or video material sent to the user by email or SMS.

In another aspect of the present disclosure, the tailored instructional material is pre-downloaded and made available to the user over the air.

In another aspect of the present disclosure, the instructional material is displayed as a pop-up in the motor vehicle.

In another aspect of the present disclosure, the ECU communicates with a storage device embedded in the motor vehicle, the storage device having a database of instructional material, the ECU correlating the low utilization code with the instructional material stored in the database and tailoring the instructional material, the ECU sending the tailored instructional material to a user of the motor vehicle.

According to several aspects, a method for low utilization monitoring includes sending instructions from a user interface to an ECU and monitoring inputs and outputs information associated with the operation of the motor vehicle. An algorithm is implemented in the ECU, the algorithm monitoring information associated with the operation of the motor vehicle, upon receiving instructions from the user interface, the ECU issuing a low utilization code based on the information.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is an overall view of a low utilization monitoring system in accordance with the principles of the present disclosure;

FIG. 1B is an expanded view of the low utilization monitoring system shown in FIG. 1A; and

FIGS. 2A and 2B are flow diagrams of the operation of the low utilization monitoring system.

### DETAILED DESCRIPTION

The following description is merely exemplary in nature and is not intended to limit the present disclosure, application, or uses.

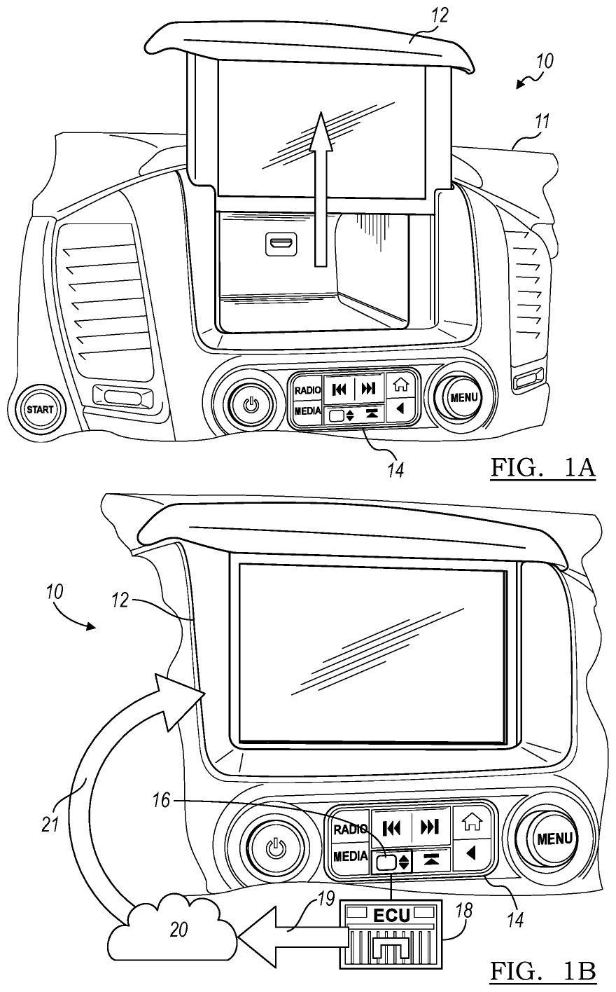

Referring to FIGS. 1A and 1B, there is shown an exemplary system 10 for low utilization monitoring of a motor vehicle. As used herein, the term “low utilization” of a functionality refers to a functionality that has not been observed or utilized on a regular basis or observed or utilized at all.

The exemplary system 10 includes a video screen 12 that can rise on a dashboard 11 to provide access to a compartment. The system 10 further includes a control panel 14 that enables a user, such as a driver or occupant, of the motor vehicle to interface with the vehicle, for example to operate the audio and video components of the infotainment system associated with the motor vehicle. The control panel 14 includes a user interface, such as, for example a button 16, that the user is able to press to select a particular function. While shown as a button 16, it will be appreciated that customer interfaces with the vehicle may be by way of various switches, levers, buttons, sensors, touch screen switches, voice commands, facial recognition systems, and combinations thereof without departing from the scope of the present disclosure.

During the operation of the motor vehicle, an electronic control unit (ECU) 18 located in the motor vehicle processes information related to the functionality of the motor vehicle. Over a period of time, some functionality of the motor vehicle may be unobserved or unused by the user of the motor vehicle. As such, the system 10 monitors the customer interfaces with the vehicle regarding the utilization of various functionalities.

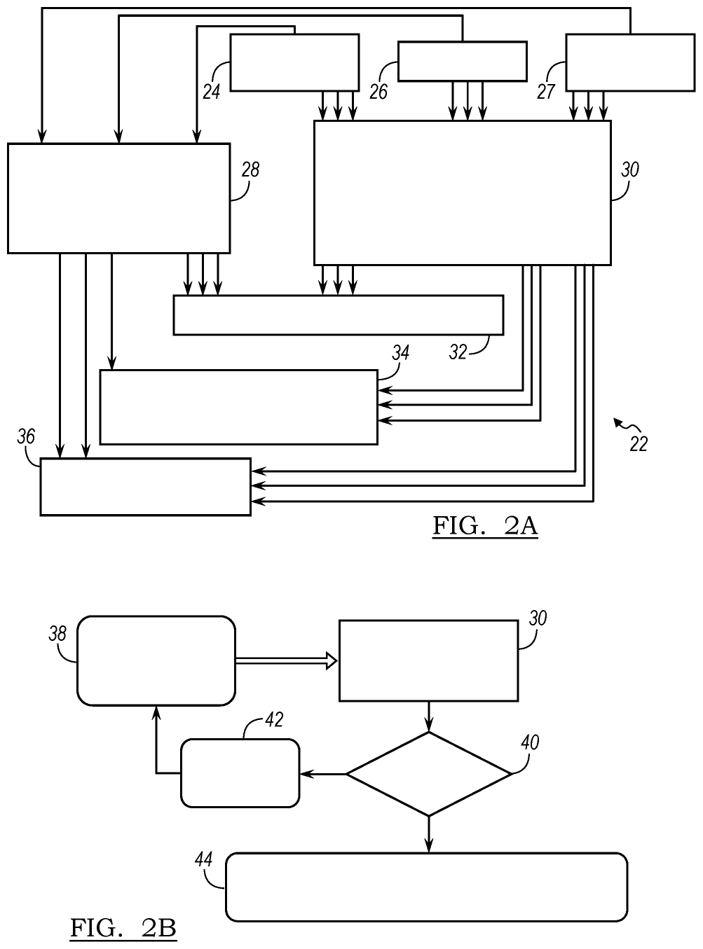

Referring now to FIG. 2A, a block diagram 22 depicting a non-limiting exemplary embodiment of the system 10 is presented. In various arrangements, an algorithm implemented in the ECU 18 monitors information associated with the operation of the motor vehicle. In particular arrangements, the algorithm is a software algorithm is software algorithm stored in a non-transitory computer readable mechanism associated with the ECU 18. As shown in FIG. 2A, the system 10 utilizes information from several sources that may be internal to or external to the ECU. These data sources include a signals, sensors and actuator interface 24, which includes signal inputs related to customer interfaces as well as analog and/or digital input/output signals associated with switches, sensors and actuators in the vehicle. Another data source is a communication and diagnostic interface 26, which may include serial communications such as CAN (Controller Area Network), LIN (Local Interconnect Network), Ethernet, etc. A third data source depicted in FIG. 2A is an internal software interface 27, which can convey information available internal to the ECU (e.g. elapsed time). Data from these data sources 24, 26 and 27 is used to establish a set of variables 30 that are monitored by the ECU 18. In particular arrangements, the ECU 18 stores each variable in non-volatile memory. In the example shown in FIG. 2A, variable 1 indicates elapsed time and variable 2 indicates that the headlights are on.

The information from the data sources 24, 26 and 27 is also sent to block 28 associated with the user's interfaces related to particular functions of the ECU (for example, the operation of switches, levers, buttons, sensors, touch screen switches/menu, etc.). Outputs from blocks 28 and 30 are combined to generate a set of functions 32, 34 36. In the non-limiting example shown in FIG. 2A, a first function 32 requested by the user may be to open the infotainment screen compartment. A second exemplary function 34 may be to lock the infotainment screen compartment when in valet mode. A generic “Nth” function 36 is also depicted to indicate that the number of functions does not have a fixed limit.

For each function 32, 32, 36, the related customer interfaces 28 required to activate that function are identified and associated with a usage flag in the ECU software. For example, three different usage flags can be can be defined for a supposed function requiring three different customer interfaces. The usage flags are employed to indicate whether a user has ever utilized a specific customer interface to activate a function or a particular sub-function. In a non-limiting exemplary arrangement, the following usage flag setting criteria is employed: default=0 (false); set value to 1 (true) when the user utilizes a function for the first time, else do nothing (set to default=0 (false)); reset to 0 (false) only when a valid “reset service request” is received (for example, when the back office detects a new user after a call to the back office).

Triggers are utilized to determine the right time to evaluate the utilization of a particular function. Triggers can also provide meaningful criteria to avoid nonsensical setting of a low utilization code for a particular function. For example, it may be desirable to avoid setting a low utilization code for an air conditioning function when three months of vehicle operation have elapsed without the external temperature of the vehicle exceeding a threshold value that would indicate the need for air conditioning. Triggers are ultimately mapped to usage flags. Turning now to FIG. 2B, after the variables 30 to be monitored are identified, the variables 30 are sent to a decision step 40. If the trigger setting criteria for the variables are not true, the variables are updated as appropriate in block 42 and the memory parameters are updated in block 38 (for example, the elapsed time is updated). The updated information is then fed back to the monitored variables 30. If the trigger setting criteria for the variables in the decision step 40 are true, then the mapping of the usage flag to the trigger is verified and the specific low utilization code is set if the usage flag is 0.

In certain arrangements, the low utilization code 19 is sent to a back office 20 remotely located from the motor vehicle. Communication of the low utilization code 19 to the back office 20 may occur during a remote diagnostic session. The back office 20 correlates the low utilization code 19 to specific instructional material hosted on, for example, a database. The back office 20 then tailors the instructional material and sends the hints or tailored instructional material 21 to the user of the motor vehicle. To ensure customer satisfaction, the instructional material from the back office 20 driven by the low utilization code 19 may include hints that are tailored to be quick and efficient tutorials.

In various arrangements, the tailored instructional material is a link to a document, while in other arrangements, the tailored instructional material is audio or visual information sent to the user, for example, by email, SMS or any other suitable means to relay the information to the user. In particular arrangements, the tailored instructional material is displayed directly on the video screen 12. For enhanced convenience, the user may benefit from having the tailored instructional material entirely pre-loaded and made available to the user over the air.

In particular arrangements, the tailored instructional material is displayed as a pop-up, for example, on the video screen 12. In certain arrangements, the user has the ability to check on the tailored instructional material at a later time or completely ignore the material. In an exemplary arrangement, the user can perform and action such as depressing button 16 to initiate retrieval of the instructional material. The user's actions are communicated back to the back office 20 (for example, during the next remote diagnostic session) for appropriate actions, for example, present the tailored instructional material 21 in the future, or not at all. Note though, that safety and other vehicle related interlocks may still apply.

In various arrangements, after the user has read, listened and or watched the hints or tailored information material, the user is asked to evaluate the material, for example, by liking or disliking the material, or giving a star rating to the material. The user feedback is sent back to the back office 20. This closed-loop feedback enables the back office 20 to improve or reconsider material with low-score indexes, for example, material that is not considered to be good by the user or features not appreciated by the user.

In other arrangements, a storage device with a database of instructional material is embedded in the motor vehicle. The algorithm in the ECU 18 correlates the low utilization code with the instructional material stored in the database and tailors the material without the use of a remote back office. The ECU 18 then sends the tailored instructional material or hints to the user by any of the aforementioned means. As such, there are no costs associated to the wireless transmission of instructional-related data (for example, video). Accordingly, the data traffic between the motor vehicle and the back office 20 can be reduced down to the low utilization codes and/or the user's closed loop feedback, if such feedback for optimizing various features is desired.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A low utilization monitoring system for a motor vehicle comprising:
a user interface; and
an electronic control unit (ECU) that receives instructions from the user interface, an algorithm being implemented in the ECU, the algorithm monitoring information associated with the operation of the motor vehicle, upon receiving instructions from the user interface, the ECU issuing a low utilization code based on the information.

2. The system of claim 1 wherein a back office collects the low utilization code from the ECU during a remote diagnostic session.

3. The system of claim 2 wherein the back office correlates the low utilization code to specific instructional material hosted on a database, the back office tailoring the instructional material and sending the tailored instructional material to a user of the motor vehicle.

4. The system of claim 3 wherein the tailored instructional material is a document sent to the user.

5. The system of claim 3 wherein the tailored instructional material is audio or video material sent to the user by email or SMS.

6. The system of claim 3 wherein the tailored instructional material is pre-downloaded and made available to the user over the air.

7. The system of claim 3 wherein the tailored instructional material is displayed as a pop-up in the motor vehicle.

8. The system of claim 2 wherein the user provides feedback regarding the tailored instructional material received.

9. The system of claim 1 wherein the algorithm is software algorithm stored in a non-transitory computer readable mechanism associated with the ECU.

10. The system of claim 1 further comprising a storage device with a database, the storage device being embedded in the motor vehicle, the algorithm correlating the low utilization code with instructional material stored in the database and tailoring the instructional material, the ECU sending the tailored instructional material to a user of the motor vehicle.

11. The system of claim 1 wherein the user interface is a button on a control panel in the motor vehicle.

12. A method for low utilization monitoring, the method comprising:
sending instructions from a user interface to an ECU; and
monitoring information associated with the operation of the motor vehicle, upon receiving instructions from the user interface, the ECU issuing a low utilization code based on the information.

13. The method of claim 12 wherein a back office collects the low utilization code from the ECU during a remote diagnostic session.

14. The method of claim 13 wherein the back office correlates the low utilization code to specific instructional material hosted on a database, the back office tailoring the instructional material and sending the tailored instructional material to a user of the motor vehicle.

15. The method of claim 14 wherein the tailored instructional material is a document sent to the user.

16. The method of claim 14 wherein the tailored instructional material is audio or video material sent to the user by email or SMS.

17. The method of claim 14 wherein the tailored instructional material is pre-downloaded and made available to the user over the air.

18. The method of claim 14 wherein the instructional material is displayed as a pop-up in the motor vehicle.

19. The method of claim 12 wherein the ECU communicates with a storage device embedded in the motor vehicle, the storage device having a database of instructional material, the ECU correlating the low utilization code with the instructional material stored in the database and tailoring the instructional material, the ECU sending the tailored instructional material to a user of the motor vehicle.

20. A method for low utilization monitoring, the method comprising:
sending instructions from a user interface to an ECU; and
monitoring inputs and outputs information associated with the operation of the motor vehicle,
an algorithm being implemented in the ECU, the algorithm monitoring information associated with the operation of the motor vehicle, upon receiving instructions from the user interface, the ECU issuing a low utilization code based on the information.
